(19) United States
(12) Patent Application Publication
(10) Pub. No.: US 2014/0193556 A1
(43) Pub. Date: Jul. 10, 2014

(54) Method for Reducing Sodium Content in Proteins

(71) Applicant: Talk of the Town Consulting, LLC, Toledo, OH (US)

(72) Inventor: Michael A. Manista, Seven Hills, OH (US)

(73) Assignee: TALK OF THE TOWN CONSULTING, LLC, Toledo, OH (US)

(21) Appl. No.: 14/141,626

(22) Filed: Dec. 27, 2013

Related U.S. Application Data
(60) Provisional application No. 61/750,912, filed on Jan. 10, 2013.

(51) Int. Cl. A23L 1/015; A23L 1/31

(52) U.S. Cl. CPC A23L 1/0152; A23L 1/31
USPC 426/437

(57) ABSTRACT

A method for reducing sodium content in proteins including the steps of placing a protein having a sodium content in a solution having acid for a predetermined period of time and removing the protein from the solution.

### RELATED APPLICATION

This is related to and claims the benefit of U.S. Provisional Patent Application No. 61/750,912, filed on Jan. 10, 2013, which is incorporated herein by reference in its entirety.

### TECHNICAL FIELD

This invention relates generally to a method for preparing food. More specifically, the invention is a method for reducing sodium content in proteins.

### BACKGROUND OF THE INVENTION

Some proteins have high levels of sodium due to processing. This is often the case with kosher proteins such as beef, veal, chicken, turkey, and lamb. It is also true with non-kosher proteins such as pork and ham. High sodium content in proteins has been found to cause health concerns among consumers.

### BRIEF SUMMARY OF THE INVENTION

The invention is directed to, among other things, a method for reducing sodium content in proteins.

### BRIEF DESCRIPTION OF THE DRAWING

FIG. 1 is a schematic diagram showing an embodiment of the method for reducing sodium content in proteins according to the invention.

### DETAILED DESCRIPTION OF THE INVENTION

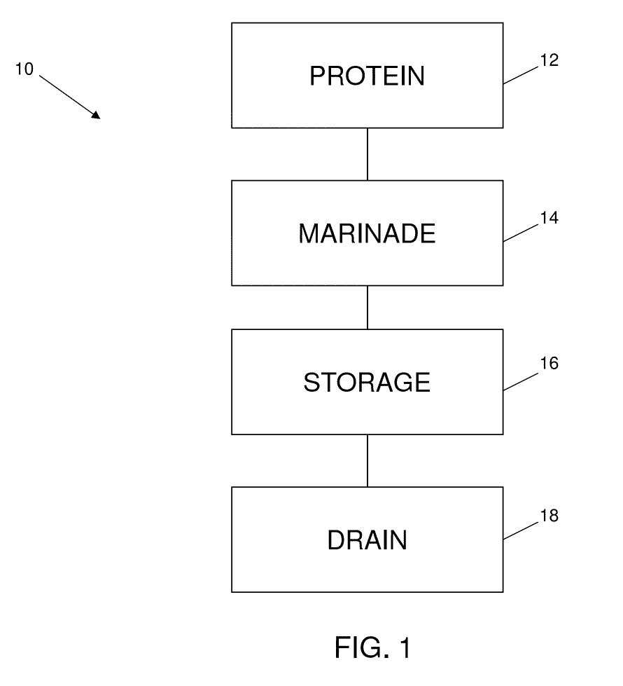

The invention will now be described in detail with reference being made to the drawing. In FIG. 1, the method of the invention is indicated generally by the reference number “10.” As shown in FIG. 1, the protein, such as beef, veal, chicken, turkey, lamb, pork, and ham, is prepared at step 12. For example, excessive fat and fluids can be removed from the protein. Further, protein can be butchered or trimmed. For example, beef can be cut for stew preparation, and chicken can be disjointed or deboned for frying, baking, and roasting. Further, protein that has been delivered from a food distributor in a precut or fabricated condition can be used.

Still referring to FIG. 1, the protein is placed in a solution or marinade at step 14. In an embodiment, the marinade is composed of water, acid, seasoning, and ice. For example, the acid is selected from the group consisting of lemon juice, lime juice, fruit juice, ascorbic acid, lactate acid, and citric acid. Further, the acid can be a combination of the acids selected from this group. The acid provides a pH balance of less than 5 pH and higher than 1.5 pH. For example, the seasoning is selected from the group consisting of no-salt seasoning, low-sodium seasoning, fresh herbs, dry herbs, and spices. Further, the seasoning can be a combination of the seasoning selected from this group. The seasoning has a sodium content of 30 mg or less per teaspoon. In an embodiment, the marinade is prepared by placing a predetermined amount of hot water (at or above 160° F.) in a suitable storage container, mixing a predetermined amount of acid and a predetermined amount of seasoning into the water, and adding a predetermined amount of ice to the mixture. The predetermined amounts of the constituents of the mixture are based, among other things, on the type of protein and the particulate size of the protein. In regard to particulate size, proteins may be used whole or cut, sliced, or diced into smaller portions.

In step 14, the protein is added to the chilled marinade and tossed until well blended. The storage container containing the protein and the marinade is then covered. In an embodiment, the storage container is marked with date, time, and temperature information.

As shown in FIG. 1, the covered storage container containing the protein and the marinade is placed in a suitable refrigeration device at step 16 for a predetermined time period depending on, for example, the type and the particulate size of the protein. For example, the predetermined time period is from about 12 hours to about 36 hours. During this step, the contents of the storage container are maintained at 34° F. or less to inhibit bacterial growth.

After the storage step 16, the storage container is removed from the refrigeration device. The protein is then removed from the container and placed in a draining device such as a colander to drain at step 18. The marinade is then discarded. In an embodiment, date and temperature information relating to the protein is collected. After draining, the protein is then ready for use or further storage. In an embodiment, the protein is cooked. In another embodiment, the protein is ready for use without cooking. It has been found that the invention reduces the sodium content of the protein.

The invention will now be illustrated by the following non-limiting examples.

### EXAMPLE 1

(1) In this example, about 20 lbs. of raw kosher boneless skinless chicken breast protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared chicken was then added to the storage container containing the marinade and gently tossed until well blended and the marinade covered the chicken. A lid was then placed on the container. The covered container was then placed in a suitable refrigeration device for about 24 hours.

(4) The covered container was then removed from the refrigeration device, the lid was then removed, and the marinated chicken was then removed from the container and placed in a colander for draining. The drained marinated chicken was then ready for use or further storage.

In this example, cooked marinated chicken had a sodium content of about 89 mg per 100 grams of chicken. In comparison, cooked chicken that was not marinated had a sodium content of about 148 mg per 100 grams of chicken. Accordingly, there was about a 40% reduction of sodium between the cooked unmarinated chicken and the cooked marinated chicken.

### EXAMPLE 2

(1) In this example, about 20 lbs. of raw kosher boneless skinless chicken thigh protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared chicken was then added to the storage container containing the marinade and gently tossed until well blended and the marinade covered the chicken. A lid was then placed on the container. The covered container was then placed in a suitable refrigeration device for about 24 hours.

(4) The covered container was then removed from the refrigeration device, the lid was then removed, and the marinated chicken was then removed from the container and placed in a colander for draining. The drained marinated chicken was then ready for use or further storage.

In this example, cooked marinated chicken had a sodium content of about 110 mg per 100 grams of chicken. In comparison, cooked chicken that was not marinated had a sodium content of about 238 mg per 100 grams of chicken. Accordingly, there was about a 54% reduction of sodium between the cooked unmarinated chicken and the cooked marinated chicken.

### EXAMPLE 3

(1) In this example, about 20 lbs. of raw kosher skin-on chicken leg protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared chicken was then added to the storage container containing the marinade and gently tossed until well blended and the marinade covered the chicken. A lid was then placed on the container. The covered container was then placed in a suitable refrigeration device for about 24 hours.

(4) The covered container was then removed from the refrigeration device, the lid was then removed, and the marinated chicken was then removed from the container and placed in a colander for draining. The drained marinated chicken was then ready for use or further storage.

In this example, cooked marinated chicken had a sodium content of about 218 mg per 100 grams of chicken. In comparison, cooked chicken that was not marinated had a sodium content of about 279 mg per 100 grams of chicken. Accordingly, there was about a 22% reduction of sodium between the cooked unmarinated chicken and the cooked marinated chicken.

### EXAMPLE 4

(1) In this example, about 20 lbs. of raw kosher boneless skinless turkey breast protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared turkey was then added to the storage container containing the marinade and gently tossed until well blended and the marinade covered the turkey. A lid was then placed on the container. The covered container was then placed in a suitable refrigeration device for about 24 hours.

(4) The covered container was then removed from the refrigeration device, the lid was then removed, and the marinated turkey was then removed from the container and placed in a colander for draining. The drained marinated turkey was then ready for use or further storage.

In this example, cooked marinated turkey had a sodium content of about 38 mg per 100 grams of turkey. In comparison, cooked turkey that was not marinated had a sodium content of about 66 mg per 100 grams of turkey. Accordingly, there was about a 42% reduction of sodium between the cooked unmarinated turkey and the cooked marinated turkey.

### EXAMPLE 5

(1) In this example, about 20 lbs. of raw kosher beef brisket protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared beef was then added to the storage container containing the marinade and gently tossed until well blended and the marinade covered the beef. A lid was then placed on the container. The covered container was then placed in a suitable refrigeration device for about 36 hours.

(4) The covered container was then removed from the refrigeration device, the lid was then removed, and the marinated beef was then removed from the container and placed in a colander for draining. The drained marinated beef was then ready for use or further storage.

In this example, cooked marinated beef had a sodium content of about 125 mg per 100 grams of beef. In comparison, cooked beef that was not marinated had a sodium content of about 242 mg per 100 grams of beef. Accordingly, there was about a 48% reduction of sodium between the cooked unmarinated beef and the cooked marinated beef.

EXAMPLE 6

(1) In this example, about 20 lbs. of raw kosher beef strips for stew protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared beef was then added to the storage container containing the marinade and gently tossed until well blended and the marinade covered the beef. A lid was then placed on the container. The covered container was then placed in a suitable refrigeration device for about 24 hours.

(4) The covered container was then removed from the refrigeration device, the lid was then removed, and the marinated beef was then removed from the container and placed in a colander for draining. The drained marinated beef was then ready for use or further storage.

In this example, cooked marinated beef had a sodium content of about 99 mg per 100 grams of beef. In comparison, cooked beef that was not marinated had a sodium content of about 343 mg per 100 grams of beef. Accordingly, there was about a 71% reduction of sodium between the cooked unmarinated beef and the cooked marinated beef.

### EXAMPLE 7

(1) In this example, about 20 lbs. of raw kosher veal stew protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared veal was then added to the storage container containing the marinade and gently tossed until well blended and the marinade covered the veal. A lid was then placed on the container. The covered container was then placed in a suitable refrigeration device for about 24 hours.

(4) The covered container was then removed from the refrigeration device, the lid was then removed, and the marinated veal was then removed from the container and placed in a colander for draining. The drained marinated veal was then ready for use or further storage.

In this example, cooked marinated veal had a sodium content of about 143 mg per 100 grams of veal. In comparison, cooked veal that was not marinated had a sodium content of about 189 mg per 100 grams of veal. Accordingly, there was about a 24% reduction of sodium between the cooked unmarinated veal and the cooked marinated veal.

### EXAMPLE 8

(1) In this example, about 20 lbs. of raw standard boneless skinless pork loin protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared pork was then added to the storage container containing the marinade and gently tossed until well blended and the marinade covered the pork. A lid was then placed on the container. The covered container was then placed in a suitable refrigeration device for about 36 hours.

(4) The covered container was then removed from the refrigeration device, the lid was then removed, and the marinated pork was then removed from the container and placed in a colander for draining. The drained marinated pork was then ready for use or further storage.

In this example, cooked marinated pork had a sodium content of about 32 mg per 100 grams of pork. In comparison, cooked pork that was not marinated had a sodium content of about 48 mg per 100 grams of pork. Accordingly, there was about a 34% reduction of sodium between the cooked unmarinated pork and the cooked marinated pork.

EXAMPLE 9

(1) In this example, about 20 lbs. of raw standard pork chops protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared pork was then added to the storage container containing the marinade and gently tossed until well blended and the marinade covered the pork. A lid was then placed on the container. The covered container was then placed in a suitable refrigeration device for about 24 hours.

(4) The covered container was then removed from the refrigeration device, the lid was then removed, and the marinated pork was then removed from the container and placed in a colander for draining. The drained marinated pork was then ready for use or further storage.

In this example, cooked marinated pork had a sodium content of about 20 mg per 100 grams of pork. In comparison, cooked pork that was not marinated had a sodium content of about 49 mg per 100 grams of pork. Accordingly, there was about a 59% reduction of sodium between the cooked unmarinated pork and the cooked marinated pork.

### EXAMPLE 10

(1) In this example, about 20 lbs. of standard processed boneless deli ham protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared ham was then added to the storage container containing the marinade and gently tossed until well blended and the marinade covered the ham. A lid was then placed on the container. The covered container was then placed in a suitable refrigeration device for about 24 hours.

(4) The covered container was then removed from the refrigeration device, the lid was then removed, and the marinated ham was then removed from the container and placed in a colander for draining. The drained marinated ham was then ready for use or further storage.

In this example, the marinated ham had a sodium content of about 748 mg per 100 grams of ham. In comparison, ham that was not marinated had a sodium content of about 992 mg per 100 grams of ham. Accordingly, there was about a 25% reduction of sodium between the unmarinated ham and the marinated ham.

EXAMPLE 11

(1) In this example, about 20 lbs. of raw kosher lamb stew meat protein was prepared and then placed in a suitable container for storage.

(2) The marinade was prepared by mixing about 12 lbs. of hot water at about 160° F. in a suitable storage container with about 5 oz. of lemon juice (bottled from concentrate), about 1.25 oz. of no-salt seasoning (Mrs. Dash® Original Blend brand), and about 16 lbs. of ice cubes (1×¼ inch cubes). The marinade was then allowed to cool to below 40° F.

(3) The prepared lamb was then added to the storage container containing the marinade and gently tossed until well blended and the marinade covered the lamb. A lid was then placed on the container. The covered container was then placed in a suitable refrigeration device for about 24 hours.

(4) The covered container was then removed from the refrigeration device, the lid was then removed, and the marinated lamb was then removed from the container and placed in a colander for draining. The drained marinated lamb was then ready for use or further storage.

In this example, cooked marinated lamb had a sodium content of about 239 mg per 100 grams of lamb. In comparison, cooked lamb that was not marinated had a sodium content of about 667 mg per 100 grams of lamb. Accordingly, there was about a 64% reduction of sodium between the cooked unmarinated lamb and the cooked marinated lamb.

While the invention has been described with reference to particular embodiments, it should be understood that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments, but that the invention shall include all embodiments falling within the scope of the claims.

What is claimed is:

1. A method for reducing sodium content in a protein comprising the steps of:
placing a protein having a sodium content in a solution of water, acid and seasoning for a predetermined period of time; and
removing the protein from the solution after the predetermined period of time.

2. The method for reducing sodium content in a protein of claim 1, wherein the protein has been koshered.

3. The method for reducing sodium content in a protein of claim 1, wherein the protein has not been koshered.

4. The method for reducing sodium content in a protein of claim 1, wherein the protein is selected from the group consisting of beef, veal, chicken, turkey, lamb, pork and ham.

5. The method of reducing sodium content in a protein of claim 1, wherein the solution includes ice cubes.

6. The method of reducing sodium content in a protein of claim 1, wherein the acid is selected from the group consisting of lemon juice, lime juice, fruit juice, ascorbic acid, lactate acid and citric acid.

7. The method of reducing sodium content in a protein of claim 1, wherein the acid provides a pH balance of less than 5 pH and higher than 1.5 pH.

8. The method of reducing sodium content in a protein of claim 1, wherein the seasoning is selected from the group consisting of no-salt seasoning, low-sodium seasoning, fresh herbs, dry herbs and spices.

9. The method of reducing sodium content in a protein of claim 1, wherein the seasoning has a sodium content of 30 mg or less per teaspoon.

10. The method of reducing sodium content in a protein of claim 1, wherein the predetermined period of time is from about 12 hours to about 36 hours.
